(19) United States
(12) Patent Application Publication
(10) Pub. No.: US 2004/0029595 A1
(43) Pub. Date: Feb. 12, 2004

(54) System and method for providing information regarding goods or services for sale via cellular telephone

(76) Inventor: Milan George Keseg, Henderson, NV (US)

Correspondence Address: WEISS & MOY PC, 4204 NORTH BROWN AVENUE, SCOTTSDALE, AZ, 85251, US

(21) Appl. No.: 10/215,988

(22) Filed: Aug. 9, 2002

(51) Int. Cl. G06F 17/60; H04M 3/42; H04M 1/00

(52) U.S. Cl. 455/456.3; 455/414.3; 379/355.01; 379/216.01; 705/14

(57) ABSTRACT

A method and system for providing sales information via cellular telephone to a person who is passing by a sales establishment. A cellular telephone companies issues an alpha-numeric store phone number to a sales establishment. The sales establishment posts the store phone number so that it will be visible to passing vehicular traffic. A person travelling in a vehicle past a sales establishment can see the store phone number, and call it on his or her cellular telephone, thereby making contact with the sales establishment in a relatively quick and convenient manner.

### FIELD OF THE INVENTION

This invention relates generally to systems and methods for providing information regarding goods and services and, more particularly, to a system and method for providing sales information via cellular telephone to a person who is passing by a sales establishment.

### BACKGROUND OF THE INVENTION

Consumers routinely drive by commercial establishments, which offer for sale goods that the consumer may be interested in purchasing. However, where the consumer lacks the time to enter the establishment, he or she has no ready method for determining whether the establishment actually has the goods or services the consumer needs, at a suitable price. The consumer could try to look up the telephone number for the establishment or call information, but by the time contact is made, the consumer may have travelled far from the establishment. Or, by the time the consumer has arrived at his or her destination, he or she has forgotten the name of the sales establishment. In either event, significant sales opportunities are being lost.

A need therefore existed for a system and method that permits consumers to receive relatively fast and easy access to information about goods or services that are available in a sales establishment that a consumer passes. The system and method should preferably permit a consumer to make direct contact with the establishment, without first having to communicate with a cellular phone service's information operator. The system and method should preferably be based on an alpha-numeric code system, that preferably permits telephone contact to be made with the dialing of less than seven (or 10) numbers. The present invention satisfies these needs and provides other, related, advantages.

### SUMMARY OF THE INVENTION

It is an object of the present invention to provide a system and method that permits consumers to receive relatively fast access to information about goods or services that are available in a sales establishment that a consumer passes.

It is a further object of the present invention to provide a system and method that permits a consumer to make direct contact with a sales establishment that the consumer passes, without first having to communicate with a cellular phone service's information operator.

It is a still further object of the present invention to provide a system and method that permits a consumer to make direct contact with a sales establishment that the consumer passes, and that is based on an alpha-numeric code system, which preferably permits telephone contact to be made with the dialing of less than seven (or 10) numbers.

### BRIEF DESCRIPTION OF THE PREFERRED EMBODIMENTS

In accordance with one embodiment of the present invention, a method for providing sales information via cellular telephone to a person who is passing by a sales establishment is disclosed. The method comprises the steps of: a sales establishment obtaining a store phone number from a cellular telephone company; wherein the store phone number comprises an alpha-numeric code; wherein the store phone number has fewer than seven digits; the sales establishment posting the store phone number so that it will be visible to vehicular traffic passing by the sales establishment; a person travelling in a vehicle seeing the store number; the person dialing the store number; and the person communicating with the sales establishment.

In accordance with another embodiment of the present invention, a method for providing sales information via cellular telephone to a person who is passing by a sales establishment is disclosed. The method comprises the steps of: a sales establishment obtaining a store phone number from a cellular telephone company; wherein the store phone number comprises an alpha-numeric code; wherein the store phone number has fewer than seven digits; the cellular telephone company placing the store phone number in a store phone number directory; the sales establishment posting the store phone number so that it will be visible to vehicular traffic passing by the sales establishment; a person travelling in a vehicle seeing the sales establishment; the person dialing contacting the store phone directory; the person communicating with the sales establishment.

In accordance with still another embodiment of the present invention, a sales information system is disclosed. The system comprises, in combination: at least one cellular telephone company; at least one sales establishment; a store phone number issued by the cellular telephone company to the sales establishment; wherein the store phone number comprises an alpha-numeric code; wherein the store phone number has fewer than seven digits; and a visible display of the store phone number; wherein the store phone number on the visible display will be visible to vehicular traffic passing by the sales establishment.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a block-type diagram, illustrating the components of a system, consistent with the present invention, for providing information regarding goods or services for sale via cellular telephone.

FIG. 2 is a flow-chart, illustrating a method, consistent with the present invention, for providing information regarding goods or services for sale via cellular telephone.

FIG. 3 is a flow-chart, illustrating a method, consistent with the present invention, for providing information regarding goods or services for sale via cellular telephone.

### DETAILED DESCRIPTION OF THE PREFERRED EMBODIMENTS

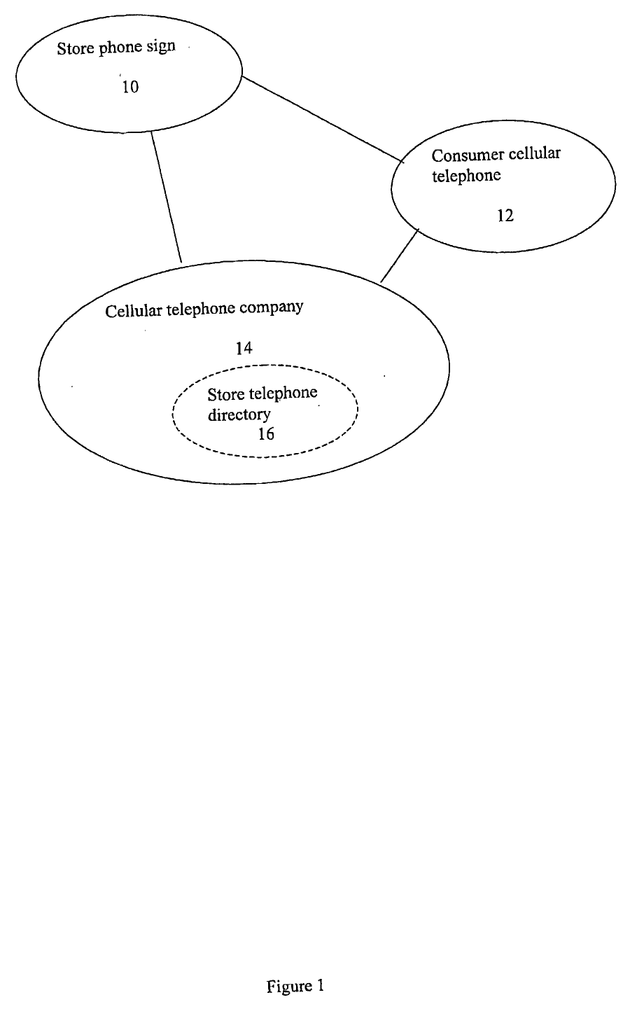

Referring first to FIG. 1, the main components of a system, consistent with the present invention, for providing information regarding goods or services for sale via cellular telephone, is shown. These include a store phone sign 10, a consumer cellular telephone 12, and a cellular telephone company 14. In one embodiment, the system further includes a store telephone directory 16.

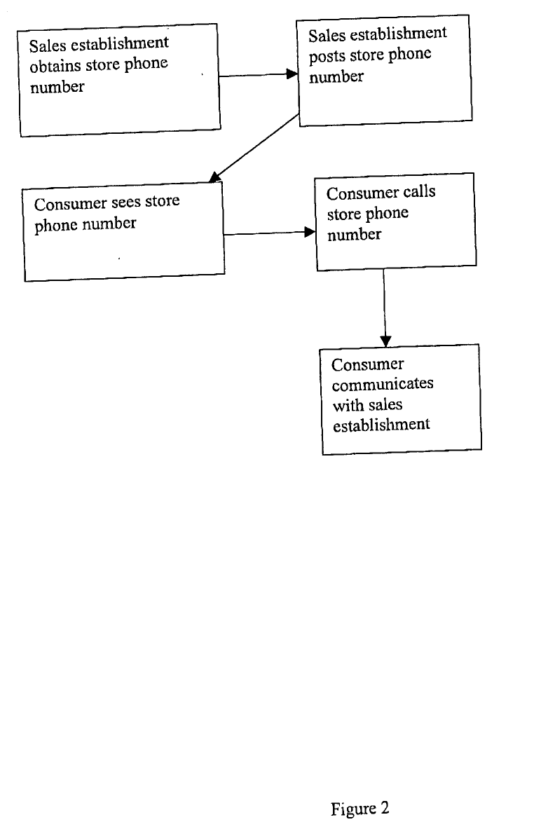

Referring now to FIG. 2, a flow chart illustrating an embodiment of a method consistent with the present invention is shown. A description of the method of FIG. 2 will further clarify the components of the system of the present invention. The first step in the method shown in FIG. 2 is the obtaining of a store phone number by a sales establishment. The store phone number is preferably (though not necessarily) alpha-numeric, and should have the fewest digits possible. (It would be particularly preferred for the store phone number have fewer than the seven or 10 digits commonly required to make a local telephone call.) The store phone number will be issued by the cellular telephone company 14. Preferably, the cellular telephone company 14 will charge the sales establishment a fee for a store phone number.

While FIG. 1 illustrates a single cellular telephone company 14, the system could be broadened to include a plurality of such companies, each issuing store phone numbers useable on their calling network.

The sales establishment will post the store phone number on a store phone sign 10. This should be a sign that is visible to passersby, and in particular to persons driving past the sales establishment in a vehicle. In this fashion, when a consumer drives past the sales establishment, he or she can see the store phone number. If interested in obtaining information about the sales establishment and/or its goods or services, the consumer will call the store phone number. The consumer is then placed in communication with the sales establishment, where he or she can either speak with a person or can be placed in communication with some type of automated information system.

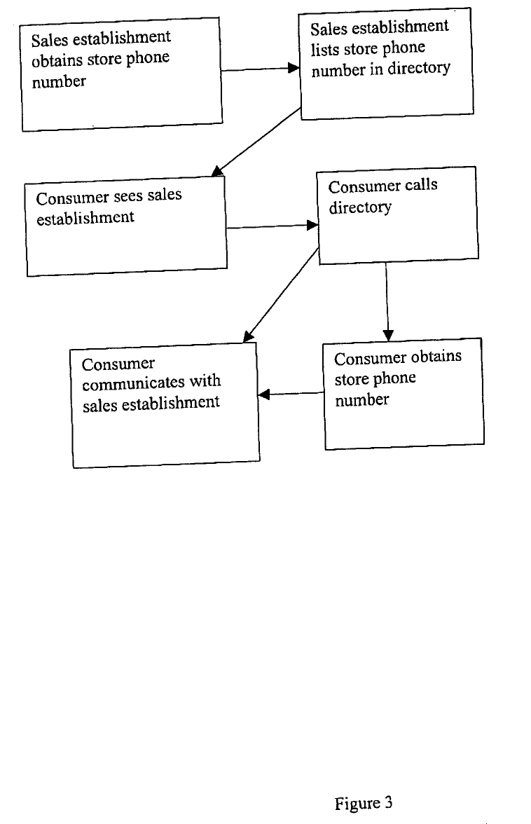

Referring now to FIG. 3, another embodiment of the system and method consistent with the present invention is illustrated. In this embodiment, and as also shown in FIG. 1, a store telephone directory 16 is also provided. The store telephone directory 16 will be provided by the cellular telephone company 14, and will include store phone numbers. In one embodiment, the cellular telephone company 14 may charge a subscription fee for inclusion in the store telephone directory 16. Alternatively, or in addition, the cellular telephone company 14 may charge the consumer a fee for calling the telephone directory 16.

Where a consumer passes by a sales establishment, and either does not see or forgets the store phone number, he or she can call the store telephone directory 16. Preferably, the store telephone directory 16 is accessible by the dialing of a short, preferably alpha-numeric, code. After the consumer identifies the name of the sales establishment, the store telephone directory can either provide the consumer with the store phone number, or directly connect the consumer with the sales establishment.

While the invention has been particularly shown and described with reference to preferred embodiments thereof, it will be understood by those skilled in the art that the foregoing and other changes in form and details may be made therein without departing from the spirit and scope of the invention.

I claim:

1. A method for providing sales information via cellular telephone to a person who is passing by a sales establishment, comprising the steps of:
a sales establishment obtaining a store phone number from a cellular telephone company;
wherein said store phone number comprises an alpha-numeric code;
wherein said store phone number has fewer than seven digits;
said sales establishment posting said store phone number so that it will be visible to vehicular traffic passing by said sales establishment;
a person travelling in a vehicle seeing said store number;
said person dialing said store number; and
said person communicating with said sales establishment.

2. The method of claim 1 further comprising the step of said sales establishment paying a fee to said cellular telephone company for said store phone number.

3. A method for providing sales information via cellular telephone to a person who is passing by a sales establishment, comprising the steps of:
a sales establishment obtaining a store phone number from a cellular telephone company;
wherein said store phone number comprises an alpha-numeric code;
wherein said store phone number has fewer than seven digits;
said cellular telephone company placing said store phone number in a store phone number directory;
said sales establishment posting said store phone number so that it will be visible to vehicular traffic passing by said sales establishment;
a person travelling in a vehicle seeing said sales establishment;
said person dialing contacting said store phone directory;
said person communicating with said sales establishment.

4. The method of claim 3, further comprising the step of said sales establishment paying a fee to said cellular telephone company for inclusion in said store phone directory.

5. The method of claim 3, further comprising the step of said consumer paying a fee for contacting said store phone directory.

6. A sales information system comprising, in combination:
at least one cellular telephone company;
at least one sales establishment;
a store phone number issued by said cellular telephone company to said sales establishment;
wherein said store phone number comprises an alpha-numeric code;
wherein said store phone number has fewer than seven digits; and
a visible display of said store phone number;
wherein said store phone number on said visible display will be visible to vehicular traffic passing by said sales establishment.

7. The sales information system of claim 6, further comprising a store phone directory containing a plurality of said store phone numbers;
wherein said store phone directory may be contacted by a person passing by said sales establishment.

8. The sales information system of claim 6, wherein said store phone directory is accessible by an alpha-numeric code.
